(19) United States
(12) Patent Application Publication
(10) Pub. No.: US 2004/0115519 A1
(43) Pub. Date: Jun. 17, 2004

(54) Recharbeable battery pack and manufacturing method thereof

(76) Inventor: Sung Hun Lee, Gyeonggi-do (KR)

Correspondence Address: MARGER JOHNSON & MCCOLLOM PC, 1030 SW MORRISON STREET, PORTLAND, OR, 97205, US

(21) Appl. No.: 10/475,055

(22) PCT Filed: Feb. 7, 2003
(86) PCT No.: PCT/KR03/00924

(30) Foreign Application Priority Data
May 9, 2002 (KR) 10-2002-0025472

(51) Int. Cl. H01M 2/34; H01M 2/24

(52) U.S. Cl. 429/61; 429/160; 429/7; 29/623.4

(57) ABSTRACT

Rechargeable battery pack interchangeable with ordinary commercial batteries, has a battery safety unit, at least two individual batteries that have a cathode and an anode and a circuit board that contains a battery safety unit designed to shut off the electric current to the battery cell when the current has been over-charged in the recharge electrode and to stop the discharge of the battery pack when the output voltage of the discharge electrode falls below a certain voltage. A cathode connecting conductor connects the recharge and discharge electrodes to the cathode terminals of the individual batteries, and an anode connecting conductor connects the recharge and discharge electrodes to the anode terminals of the individual batteries. A cover contains the circuit board and ties the individual batteries, the cathode connecting conductor, the anode connecting conductor and the circuit board as a single battery pack format in the individual battery's upper and lower bodies. At least one of the cathode connecting conductor and the anode connecting conductor is electrically connected to the circuit board. The battery pack of this invention can be, for example, made of lithium ion battery and used in portable electronic devices such as a digital camera.

### TECHNICAL FIELD

This invention generally relates to the rechargeable battery technology, and more particularly to the battery pack including several rechargeable batteries, that is interchangeable with ordinary commercial batteries and includes a battery safety unit (BSU).

### BACKGROUD ART

Different from the disposable battery (such as mercury battery, Manganese battery, Alkaline battery and Lithium battery) that must be discarded once the stored energy has been exhausted, rechargeable battery can be reused by recharging the battery's exhausted electric energy from external sources and is presently in wide use. The demand for rechargeable battery in portable consumer electronics such as mobile phone, PDA, laptop computer and digital camera is increasing, mainly because rechargeable battery is reusable and has bigger capacity than disposable battery.

Disposable battery is manufactured in one of the AAA, AA, C, or D standards and thus different from the standards for the rechargeable battery. Consequently, it is difficult to interchange rechargeable battery with the ordinary commercial battery, and several disposable batteries must be used in order to meet the voltage or electric current required by the portable electronic appliances. In addition, even when several rechargeable batteries are used in order to obtain sufficient capacity and lengthen the usage time, one faces with a shortcoming that it takes a long time to recharge those rechargeable batteries. Furthermore, there is a battery cell that combines multiple disposable batteries in the portable electronic appliances, but no rechargeable battery pack that meets the same standards has been developed. The result is that interchange with the disposable battery cell is not possible, and accordingly, the battery life for the portable electronic appliances is short and impossible to recharge.

### DISCLOSURE OF THE INVENTION

The purpose of this invention is to lengthen the battery's lifespan in the portable electronic appliances by constructing multiple rechargeable batteries as a single battery pack, and to reuse the batteries by enabling them rechargeable.

Another objective of this invention is to provide a rechargeable battery pack that has a bigger capacity for electric energy, that is easily and quickly rechargeable, and that is interchangeable with the ordinary commercial battery or a disposable battery (dry cell).

Finally, this invention seeks to improve the battery's reliability by constructing a battery safety unit, along with rechargeable battery, into a single battery pack.

The battery pack constructed by this invention is recharge/discharge-capable, and includes more than two individual batteries that have cathode and anode terminals. The battery pack includes a recharge electrode, a discharge electrode, a circuit board that contains a battery safety unit designed to shut off the electric current to the battery cell when the current has been over-charged in the recharge electrode and to stop the discharge of the battery pack when the output voltage of the discharge electrode falls below a certain voltage, a cathode connecting conductor that connects the recharge and discharge electrodes to the cathode terminal of an individual battery, an anode connecting conductor that connects the recharge and discharge electrodes to the anode terminal of an individual battery, and a cover that contains the circuit board and ties two or more individual batteries, the cathode connecting conductor, the anode connecting conductor and the circuit board as a single battery pack format in the individual battery's upper body that has a cathode terminal and in its lower body that has a anode terminal. At least one of the cathode connecting conductor and the anode connecting conductor mentioned above is electrically connected to the circuit board.

According to one aspect of the present invention, a battery pack includes a recharge electrode, a discharge electrode, a circuit board that contains a battery safety unit designed to shut off the electric current flowing into the battery cell when the current has been over-charged in the recharge electrode and to stop the discharge of the battery pack when the output voltage of the discharge electrode falls below a certain voltage, a cathode connecting conductor that electrically connects the recharge electrode to the cathode terminals of individual batteries by connecting them in a series, an anode connecting conductor that connects the anode terminals of individual batteries in a series and electrically connects them to the recharge electrode through the battery safety unit in the circuit board, a fixing cap that holds the circuit board, and a cover that ties two or more individual batteries, the fixing cap, the cathode connecting conductor, the anode connecting conductor and the circuit board as a single battery pack format in an individual battery's upper body that has a cathode terminal and in its lower body that has an anode terminal.

According to other aspect of the present invention, a battery pack includes a recharge electrode, a discharge electrode, and a circuit board that contains a battery safety unit designed to shut off the electric current to the battery cell when the current has been over-charged in the recharge electrode and to stop the discharge of the battery pack when the output voltage of the discharge electrode falls below a certain voltage. The battery pack also contains a cathode connecting conductor for electrically connecting the cathode terminal of an individual battery to the recharge and discharge electrodes, an anode connecting conductor for electrically connecting the anode terminal to the recharge and discharge electrodes through the battery safety unit in the circuit board, and a cover that ties two or more individual batteries, the cathode connecting conductor, the anode connecting conductor and the circuit board as a single battery pack format in the individual battery's upper body that has a cathode terminal and its lower body that has a anode terminal. The cathode connecting conductor includes a first plate-shaped connecting conductor that is directly connected to the cathode terminals of the individual batteries and a first line-shaped sub-conductor that attaches to a first insulator plate and connects with the first connecting conductor by extending to the anode terminal of the individual batteries. The anode connecting conductor includes both the second plate-shaped connecting conductor that directly connects with the anode terminals of the individual batteries and a second line-shaped sub-conductor that attaches to a second insulator plate and connects with the second connecting conductor by extending to the cathode terminal.

The construction of a battery safety unit in this invention may be one that contains a cut-off switch connected between the battery pack and external electronic appliances or external recharging devices, a voltage sensor that senses the output voltage of the battery pack, a first voltage comparator that turns on the cut-off switch when the output voltage is higher than a fixed voltage for over-charge, the second voltage comparator that turns on the cut-off switch when the voltage is lower than a fixed voltage for over-discharge. Another construction may be one that contains a circuit controller that connects the electrodes, switches and individual batteries, an overcharge detector that turns off the recharging switch through the circuit controller when the voltage of the battery pack is higher than a fixed voltage for over-charge, an over-discharge detector that turns off the discharge switch through the circuit controller when the voltage falls below a fixed voltage for over-discharge, an over-current detector that turns off the discharge switch when the discharge current of the battery pack is over a fixed value, and a short-circuit detector.

It is also possible to use a constant voltage circuit that maintains a constant output voltage of the battery pack, separate from the battery safety unit.

### BRIEF DESCRIPTION OF THE DRAWINGS

FIG. 1 is a perspective view of the break-down of the battery pack (100) according to a first embodiment of this invention.

FIGS. 2a and 2b are perspective views of the connection structure of the top and bottom covers that can be used in the first embodiment.

FIGS. 3a and 3b are front and base views of the upper circuit board that can be used in the first embodiment.

FIGS. 4a and 4b are front and base views of the lower circuit board that can be used in the first embodiment.

FIG. 5 is a perspective view showing the electric connection structure of cathode connecting conductor, batteries and circuit board in battery pack according to the first embodiment.

FIG. 6 is a perspective view showing the electric connection structure of the first anode connecting conductor, the second anode connecting conductor, batteries and circuit board in battery pack according to the first embodiment.

FIGS. 7a to 7f are perspective views illustrating the manufacturing processes of battery pack according to the first embodiment.

FIG. 8 is a perspective view of the break-down of battery pack (200) according to the second embodiment.

FIG. 9a is a perspective view of the assembled battery pack according to the second embodiment with the discharge terminal shown.

FIG. 9b is a perspective view of the assembled battery pack according to the second embodiment with the recharge terminal shown.

FIG. 10 is a perspective view of the battery pack's exterior after individual batteries (210a, 210b) are assembled and packaging label (290) is attached to them.

FIG. 11 is a block circuit diagram that illustrates a battery safety unit (350) and a constant voltage circuit (360) of the first circuitry example which can be included in the battery pack according to the first and second embodiments.

FIG. 12 is a block circuit diagram that illustrates the battery safety unit and a constant voltage circuit of the second circuitry example of which can be included in the battery pack according to the first and second embodiments.

FIG. 13 shows the output voltage characteristics of the battery pack.

FIG. 14 shows the output voltage characteristics of the battery pack of the present invention when compared with conventional Nickel Hydrogen batteries.

FIG. 15 shows the recharge voltage characteristics of the battery pack.

FIG. 16 shows the recharge characteristics of the battery pack.

FIG. 17a is a perspective view of an exterior shape of the battery pack (600).

FIG. 17b is a perspective view which provides another example of the battery pack's exterior shape (700).

### BEST MODES FOR CARRYING OUT THE INVENTION

The preferred embodiments of this invention will be discussed with reference to Figures. The embodiments expressed in the Figures are for explaining the construction and effects of this invention and not to define or limit the scope of this invention. The structures on the Figures are expressed neither in the actual sizes nor in the accurate proportion to the actual sizes. The same numberings are used for the same or corresponding structures in the Figures.

First Embodiment

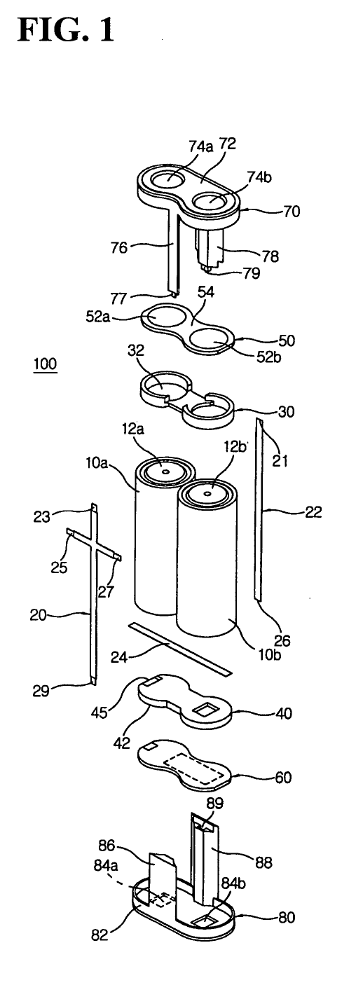

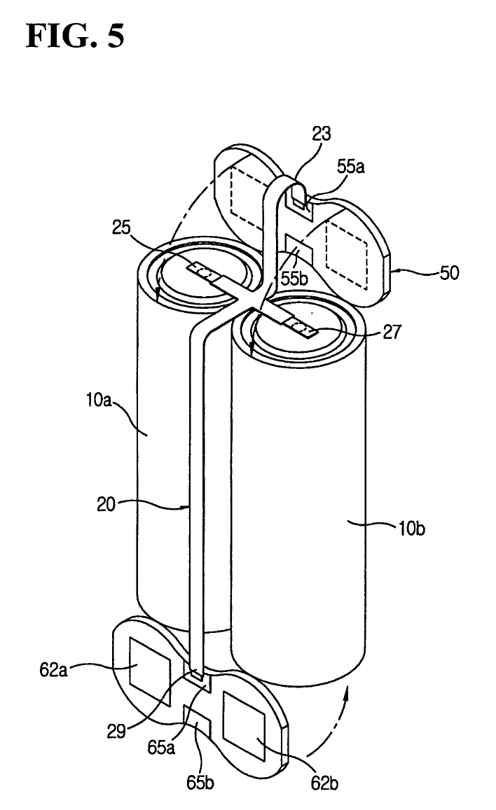

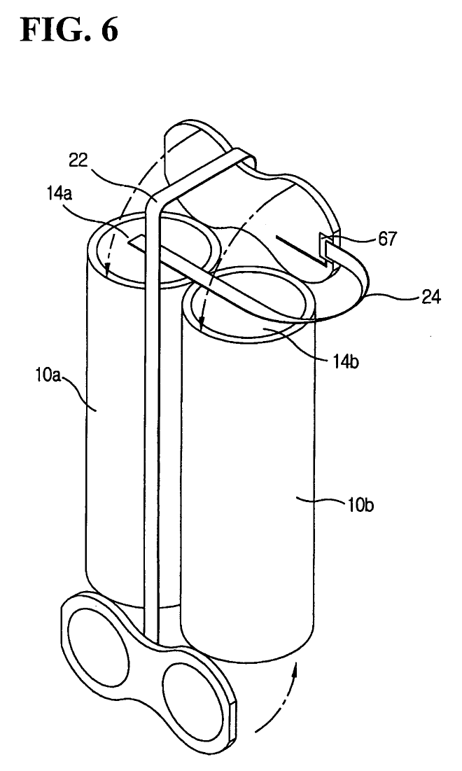

FIG. 1 is a perspective view of the battery pack constructed according to the first embodiment for this invention. The battery pack (100) contains two individual batteries (10a, 10b) as well as connecting conductors which electrically connect these batteries. Individual batteries (10a, 10b) include Nickel Cadmium (Ni—CdO) batteries which use Ni(OH)₂ as the cathode, Cd as the anode and alkali aqueous solution as electrolytes, Nickel hydrogen (NiMH) batteries which use Ni(OH)₂ as the cathode, metal hydride (MH) as the anode and alkali aqueous solution as electrolytes, and Lithium Ion (Li-Ion) batteries which use carbon (C) or graphite as the anode, LiCoO₂ as the cathode and Lithium-Salt organic solvent as electrolytes. However, it is advisable to use Lithium-Ion (Li-Ion) batteries for the individual batteries. Lithium-Ion (Li-Ion) batteries are 40-50% smaller than Nickel Cadmium batteries and 20-30% smaller than Nickel Hydrogen batteries. Although approximately 50% lighter in weight, Li-Ion batteries are of high energy density and of high output capacity, use no contaminants such as cadmium, lead and mercury, and have a long battery life. Another advantage of using Li-Ion batteries is that they are not prone to the memory effects and have a short recharging time. Owing to these advantages, Li-Ion batteries are suitable to be used as power supply of portable consumer electronic devices. Notwithstanding that FIG. 1 depicts batteries (10a, 10b) as cylindrical, batteries with other shapes can also be used. Connecting conductors, which electrically connect individual batteries (10a, 10b) with the outside, include a cathode connecting conductor (20), the first anode connecting conductor (22), and the second anode connecting conductor (24). Electrical connection structures (see FIGS. 5 and 6) of the batteries will be discussed later.

Cathode (12a, 12b) and anode (14a and 14b in FIG. 6) terminals of individual batteries (10a, 10b) are each connected to the upper and the lower circuit boards (50, 60) through the connecting conductors. The upper circuit board (50) has a discharge cathode terminal and discharge anode terminal, whereas the lower circuit board (60) has a recharge cathode terminal (62a) and a recharge anode terminal (62b). Thus, the electrical energy within the individual batteries (10a, 10b) are exported to the outside through conductors (20, 22, 24) and discharge terminals (52a, 52b), and the exhausted electrical energy of these batteries can be recharged from external sources through the recharge terminals (62a, 62b).

The upper circuit board (50) is attached to the upper part of the batteries (10a, 10b) by the upper fixing cap (30) while the lower circuit board (60) is attached to the lower part of the batteries (10a, 10b) by the lower fixing cap. The ‘upper’ and the ‘lower’ here only serve as mere terms used to distinguish top and bottom in FIG. 1, and thus the part designated as ‘upper’ part does not have to be the area in which the battery cathode is located. The upper cap (30) is composed of an opening (32) that is capable of holding the upper circuit board (5), and the lower cap (40) is composed of an opening and an indentation (45), each capable of holding the lower circuit board and curved parts of the second anode connecting conductor (24) respectively.

The upper cap (30) accommodated by the upper circuit board (50) is attached to the upper part of the battery pack (100) by the upper cover (70), while the lower cap (40) accommodated by the lower circuit board (60) is attached to the lower part of the battery pack (100) by the lower cover (80).

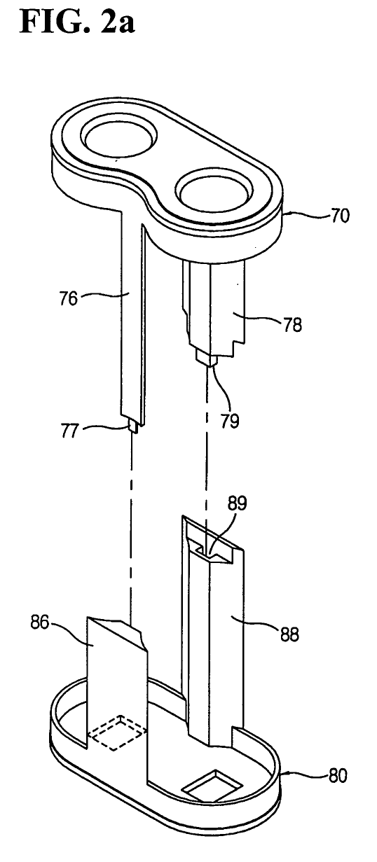

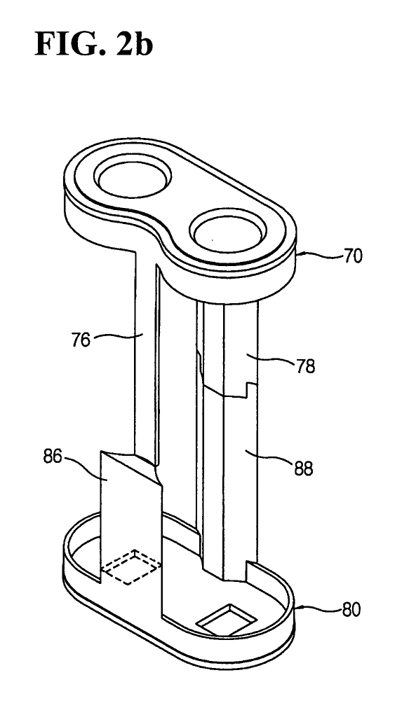

The upper cover (70) and the lower cover (80), as shown in FIGS. 2a and 2b, are joined together so that the components of the battery pack can form a single body. The upper cover (70) includes the main cover body (72), penetration holes (74a, 74b) formed in the body, and the first (76) and the second (78) connecting legs projected downward from both sides of the main body. On the other hand, the lower cover (80) includes the main cover body (82), penetration holes (84a, 84b), and the first (86) and the second (88) connecting legs projected downward from both sides of the main body. The penetration hole (74a, 74b) of the upper and the lower covers (70, 80) as well as the penetration hole (84a, 84b) respectively render the discharge cathode terminal (52a) of the upper circuit board (50), the discharge anode terminal (52b), the recharge cathode terminal (62a), and the recharge anode terminal (62b) exposed to the outside.

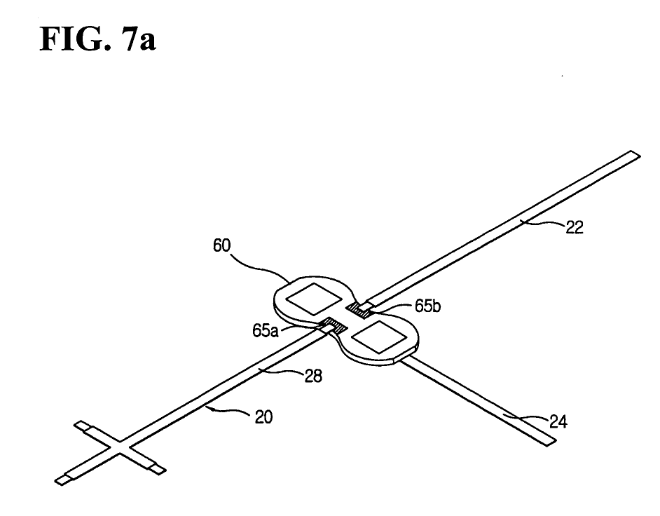

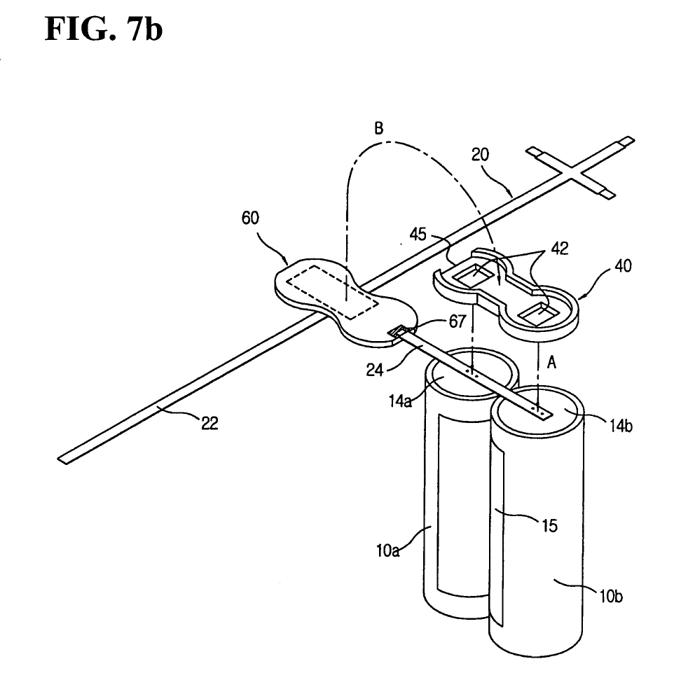

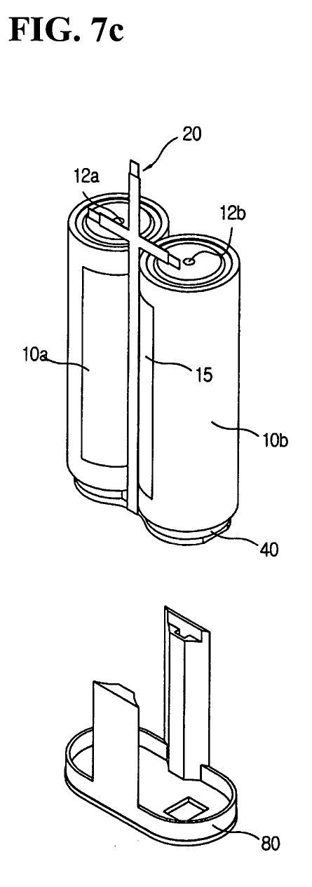

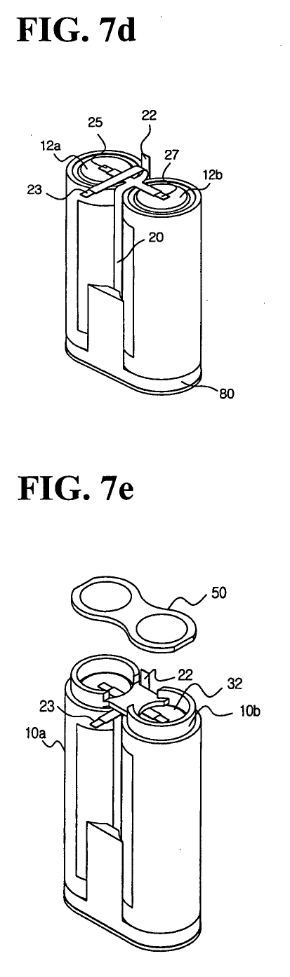

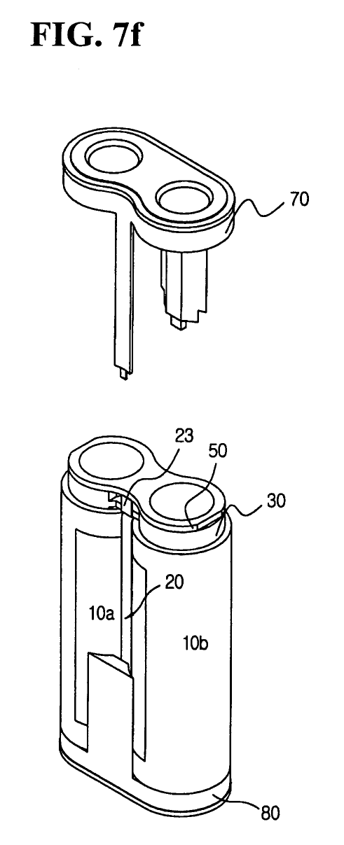

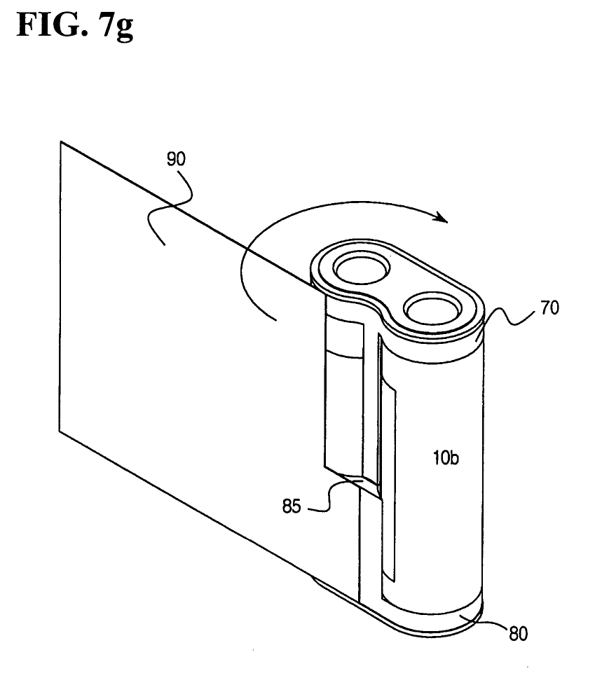

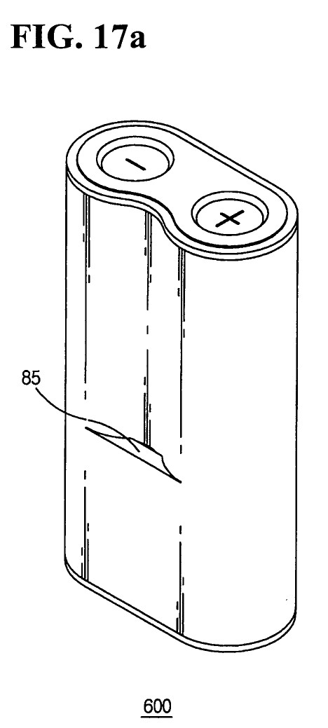

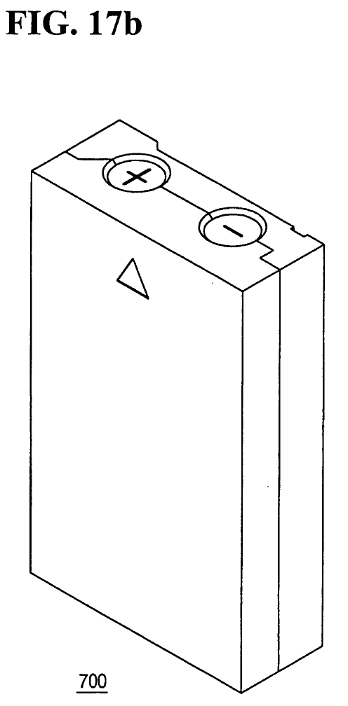

On the other hand, at the end of the first connecting leg (76) of the upper cover (70) exists a coupling rib whose insertion into the hole formed at the end of the second connecting leg (88) couples the upper cover (70) with the lower cover (80). Meanwhile, the projection part (77) which is formed at the end of the second connecting leg (78) of the upper cover (70) touches the inner side of the first connecting leg (86) rather than being directly coupled to the first leg (86) of the lower cover (80). The reason for having the second connecting leg (78) of the upper cover (70) coupled to the first connecting leg (86) of the lower cover through contact is to prevent reverse insertion of cathode and anode terminals when a step (85) is formed, as illustrated in FIGS. 7g and 17a, near the middle of one side of a completely assembled battery pack, which is then inserted into electronic machines or recharging devices. Such a step (85) is not a necessary component of the present invention. Thus, it is possible to directly couple the second connecting leg (78) of the upper cover (70) with the first connecting leg (86) of the lower cover (80) and thereby to fix them.

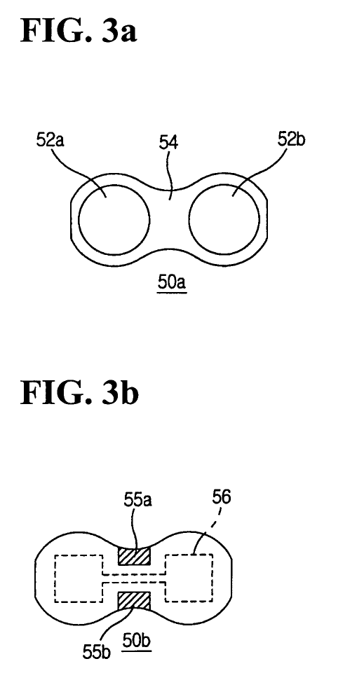

FIGS. 3a and 3b are the front and the back illustrations of the upper circuit boards (50) which can be used in the first embodiment. Printed circuit board (PCB) may be used as the circuit board (50).

The front side of the upper circuit board (50) has a discharge cathode terminals (52a) and discharge anode terminals (refer to FIG. 3a). The cathode connecting terminal (55a) and the anode connecting terminal (55b) are formed at the back side (50b) of the circuit board (50) (refer to FIG. 3b). As illustrated in FIG. 3b, the back side (50b) of the circuit board (50) has a constant voltage circuit (56). At the front (50a) and the back (50b) sides of the circuit board (50) exist conductor patterns which serve to electrically connect the constant voltage circuit (56) with the terminals (52a, 52b), conductor patterns which serve to connect terminals (55a, 55b) with the circuit and/or the cathode and anode terminals (52a, 52b), and circuit patterns which serve to make up the constant voltage circuit (56), all of which are not shown in the Figures to make the Figures simple.

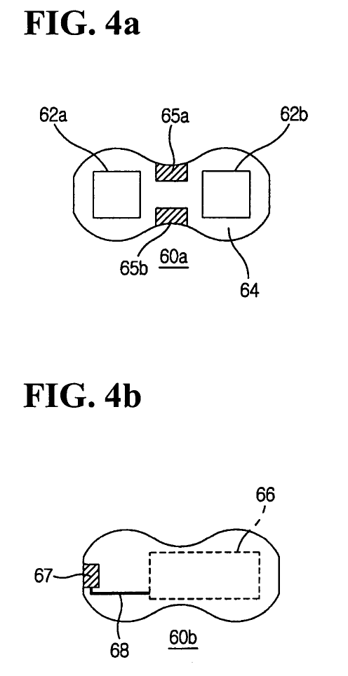

The lower circuit board (60), which is shown in FIGS. 4a and 4b, can also form PCB in the same manner as the upper circuit board (50) does. At the front side (60a) of the circuit board (60) exist the recharge cathode terminal (62a), the recharge anode terminal (62b), the P+1 terminal (65a) and the P−1 terminal (65b). On the other hand, the B-terminal (67), which is electrically connected to the safety unit (66) through wires (68), is formed at the back side (60b) of the circuit board (60).

The terminals (52a, 52b, 62a, 62b) in the circuit boards (50, 60) illustrated in FIGS. 3 and 4 are composed of metallic nickel or copper, and their surface can be plated with gold in order to reduce electrical resistance of the terminals. Such surface gold plating can also be applied to conductor terminals (65a, 65b, 67). On the other hand, those who have ordinary skill in the art can easily understand that the arrangement of the cathode terminals, the anode terminals and the connecting terminals as shown in FIGS. 3 and 4 is merely illustrative, that it does not deviate from the scope of the present invention, and that the location of the terminals can be possibly changed.

FIG. 5 is an illustration designed to show the electrical connection structure among cathode connecting conductor (20), individual batteries (10a, 10b), the upper and the lower circuit boards (50, 60) and cathode terminals (52a, 62a) according to the first embodiment.

The cathode connecting conductor (20), shaped like a cross, is composed of metallic nickel, and it contains the upper lead (23), the left lead (25), the right lead (27) and the lower lead (29), all of which can be coated with highly conductive metals such as gold, whereas the main body of conductors excluding the lead can be attached to the insulation tapes (‘28’ in FIG. 7a) or plated with isolation coating (refer to FIG. 5). The upper lead (23) of the cathode connecting conductor (20) is connected by soldering to the cathode connecting terminal (55a) of the upper circuit board (50), while the left lead (25) is connected by soldering to the cathode terminal (12a), the right lead (27) to the cathode terminal (12b) of battery 10b, and the lower lead (29) to the P+1 terminal (65a) of the lower circuit board (60).

FIG. 6 illustrates the electrical connection structure among anode connecting conductors (22, 24), individual batteries (10a, 10b), the upper and the lower circuit boards (50, 60) and anode terminals (52b, 62b) in the first embodiment.

The first anode connecting conductor (22), forming a straight line, is connected by soldering to the anode connecting terminal (55b) of the upper circuit board (50) and to the P−1 terminal (65b) of the lower circuit board (60). On the other hand, the second anode connecting conductor (24) is connected by soldering to anode terminals (14a, 14b) in order to connect the anode terminals (14a, 14b) of the batteries (10a, 10b) in a series, and its one end is connected by soldering to the B-terminal (67) of the lower part circuit board (60).

According to the electrical interconnection structures as shown in FIGS. 5 and 6, discharge (i.e., output) cathode power can be supplied to the outside through the following path: 1) the cathode terminals (12a, 12b) of the individual batteries (10a, 10b); 2) the right (25) and left (27) leads, and the upper (23) lead of the cathode connecting conductor (20); 3) the constant voltage circuit (56) of the upper circuit board (50); and 4) the discharge cathode terminal (52a) of the upper circuit board (50). On the other hand, discharge anode power is supplied to the outside through: 1) the anode terminals (14a, 14b) of individual batteries (10a, 10b); 2) the second anode connecting conductor (24); 3) the B-terminal (67) of the lower circuit board (60); 4) the safety unit (66) of the lower circuit board (60); 5) the P−1 terminal (65b) of the lower circuit board (60); 6) the first anode connecting conductor (22); 7) the anode connecting terminal (55b) of the upper circuit board (50); and 8) the discharge anode terminal (52b) of the upper circuit board (50).

As explained above with references to FIGS. 5 and 6, cathode terminals of the individual batteries (10a, 10b) are connected amongst cathode terminals, whereas anode terminals are connected amongst anode terminals. Thus, the batteries (10b, 10b), constituting a single battery pack, are electrically connected to each other in parallel.

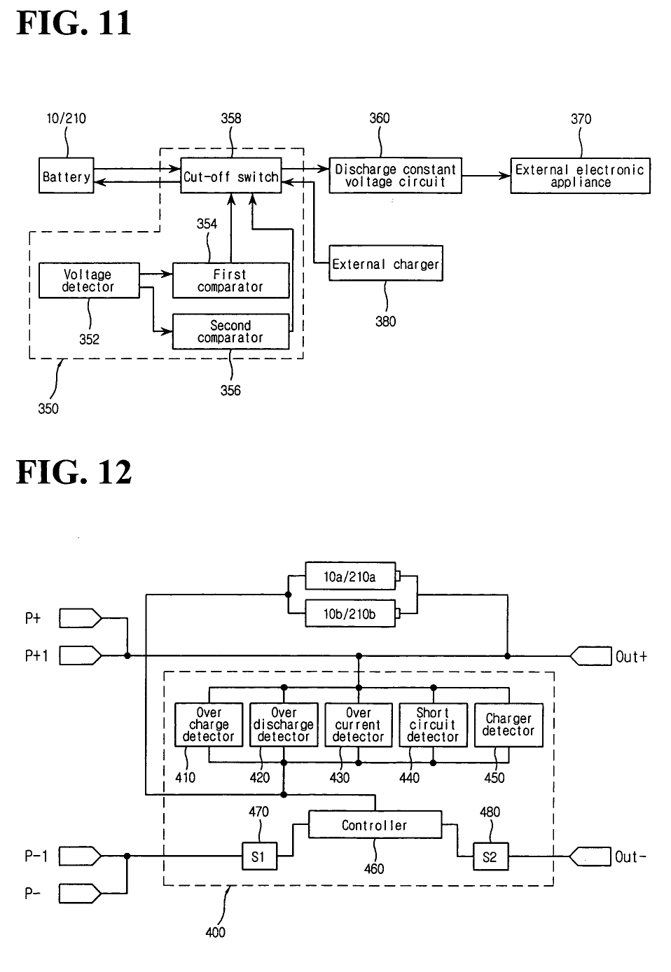

On the other hand, recharge positive power supply furnishes electrical recharge energy to the cathode electrodes (12a, 12b) of the individual batteries (10a, 10b) through: 1) external recharge power supply (‘380’ in FIG. 11); 2) the recharge cathode electrode (62a) of the lower circuit board (60); 3) the P+1 electrode (65a) of the lower circuit board (60); and 4) the lower, the right, and the left leads (29, 25, 27) of the cathode connecting conductor (20). Recharge negative power supply furnishes electrical charge energy to the anode electrodes (14a, 14b) of the individual batteries (10a, 10b) through: 1) external charge power supply; 2) the recharge anode electrode (62b) of the lower circuit board (60); 3) the B-electrode (67) of the lower circuit board (60); and 4) the second anode connecting conductor (24). When Li-Ion batteries constitute the battery pack, it is desirable to use a fixed-current-and-constant-voltage charger for recharging batteries.

When the battery pack of the present invention is composed of Li-Ion batteries, Li ions flow off from LiCoO₂ to anode crystals when electrical charge energy is supplied to the battery pack. On the other hand, when the battery pack is discharged, a reverse reaction occurs, and Li ions flow off from the graphite lattice structure of the anode to the crystal structure of the cathode by drifting into electrolytes. That is, Li ions move back and forth between the cathode and the anode when the battery pack is recharged or discharged.

Assembly Processes of the Battery Pack of the First Embodiment

Assembly processes of the battery pack (100) constructed according to Implementation example 1 of the present invention will be explained by referring to FIGS. 7a to 7f.

As shown in FIG. 7a, the cathode connecting conductor (20) is connected by soldering to the P+1 terminal (65a) of the lower circuit board (60), the first anode connecting conductor (22) to the P−1 terminal (65b), and the second anode connecting conductor (24) to the B−1 terminal (67). The cross-shaped body of the cathode connecting conductor (20), excluding the end part of lead, is attached to isolation tape (28) or isolation-coated. The reason why only the cathode connecting conductor (20), unlike the anode connecting conductors (22, 24), is insulation-treated is that the surface of the individual batteries (10a, 10b) itself functions as a grounding conductor, that is, the anode, and thus it is necessary to prevent the cathode connecting conductor (20) from conducting from the battery surfaces.

As shown in FIG. 7, the second anode connecting conductor (24) is connected by soldering to the anode terminals (14a, 14b) of the individual batteries (10a, 10b) which are connected to each other by adhesive tape (15) or adhesives. Then, a lower fixing cap (40) is assembled (arrow A) and the lower circuit board (60) is inserted into the lower fixing cap (40, arrow B). The lower circuit board (60) is received by the opening (42), and the second anode connecting conductor (24) is curved along the indentation (45).

As shown in FIG. 7c, the cathode connecting conductor (20) and the first anode connecting conductor (22) are bent and attached to the middle of the main body side of the batteries (10a, 10b) which are joined with the lower cap (40), and then they are inserted into the lower cap (80) of the anode terminal side.

As shown in FIG. 7d, the right and the left leads (25, 27) of the cathode connecting conductor (20) is connected by soldering to the cathode terminals (12a, 12b) of the batteries (10a, 10b) to which the lower cover (80) is fixed.

As shown in FIG. 7e, the upper fixing cap (30) is assembled at the cathode terminal sides (12a, 12b) to which the right and the left leads (25, 27) of the cathode connecting conductor (20) are connected. After the upper lead (23) of the cathode connecting conductor (20) is connected by soldering to the cathode connecting terminal (55a) as explained above (refer to FIG. 5) and the first anode connecting conductor (22) is connected by soldering to the anode connecting terminal (55a) of the upper circuit board (50) as explained above (refer to FIG. 6), the upper circuit board (50) is assembled at the upper cap (30). Circuit parts constituting the upper circuit board (50) are stored in the opening (32) of the upper cap (30).

As illustrated in FIG. 7f, the upper cap (70) and the lower cover (80) are coupled by assembling the upper cover (70) as explained above (refer to FIGS. 2a and 2b) at the cathode side of the batteries where the upper cap (30) and the circuit board (50) have been assembled.

As shown in FIG. 7g, in order to completely shield the body of the batteries, which have been combined into one body by the upper and the lower covers (70, 80), a packing label is attached to the body. At this time, a packing label (90) can be made in such a manner that the label is not attached to the step (85), leaving the step (85) exposed to the outside. A completely assembled battery pack goes through a series of electrical characteristic and reliability tests as well as naked eye inspections.

The battery pack of this invention, internally constructed in this manner, can have diverse external structures. For example, the battery pack can be of CRV3 compatible as illustrated in FIG. 17a or of hexahedral shape as illustrated in FIG. 17b. These external structures of the battery pack are similar to those in the following the second embodiment.

Second Embodiment

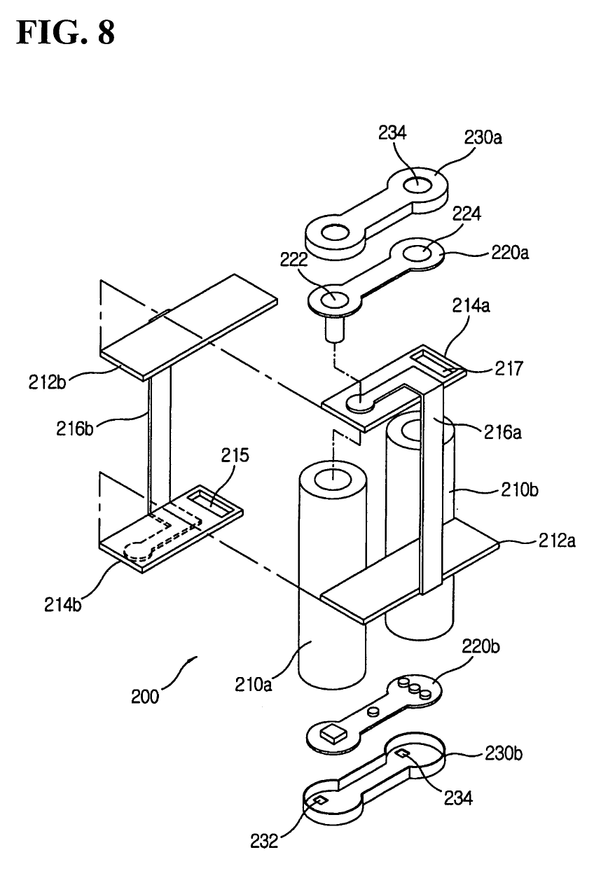

FIG. 8 is a break-down perspective view of the battery pack (200) according to the second embodiment.

Cathode terminals and anode terminals of the individual batteries (210a, 210b) are connected among cathode terminals and among anode terminals respectively, and thereby the individual batteries, electrically connected to each other in a row, form the battery pack (200). These individual batteries are electrically connected by a plate-shaped connecting conductor (212) and a line-shaped sub-conductor (216). The sub-conductor (216) is connected to the connecting conductor (212) in order to have both cathode and anode output terminals formed at both sides of the upper and lower parts of the battery pack (200), whereas the lengthened sub-conductors (216) are each located at the opposite sides of the battery pack (200) so to form different electrodes at each side of the battery pack (200). Between the connecting conductor (212) and the sub-conductor (216) is placed an isolation plate in order to prevent electrical short-circuit of the connecting conductor (212) and the sub-conductor (216).

For example, as shown in FIG. 8, the discharge cathode terminal (222) formed at the upper circuit board (220) is connected by soldering to the first sub-conductor (216a) and thereby is electrically connected to the cathode terminal (that is, the battery terminal formed at the lower side of the individual batteries in FIG. 8) through the first connecting conductor (212a). Here, arranged above the first isolation plate (214a), the first sub-connecting conductor (216a) is not connected to the anode terminal (that is, the battery terminal formed at the upper side of the individual batteries in FIG. 8) of the batteries (210a, 210b). On the other hand, the discharge anode terminal (224) of the upper circuit board (220a) is connected by soldering to the second connecting conductor (212b), thereby electrically connected to the anode terminals of the batteries. For the connection between the discharge anode terminal (224) and the second connecting conductor (212b), the first isolation plate (214a) has a penetration hole (217). The upper circuit board (220a) is stored into and fixed by the upper cover (230a). The upper cover (230a) is of shape corresponding to a section of battery and includes space capable of holding the circuit board (220a). The two penetration holes (234) formed on the upper cover (230a) makes the discharge cathode terminal (222) and the discharge anode terminal exposed to the outside.

On the other hand, the recharge anode terminal (232), connected with the second sub-conductor (216b) through the lower circuit board (220b), is linked to the anode terminals of the batteries (210a, 210b) through the second connecting conductor (212b). The recharge cathode terminal (234) is connected with the cathode terminal of the batteries through the lower circuit board (220b) and the first connecting conductor (212a). For the electrical connection between the recharge cathode terminal (234) and the first connecting conductor (212a), the second isolation plate (214b) has a penetration hole (215). The lower circuit board (220b) is stored into and fixed by the lower cover (230b).

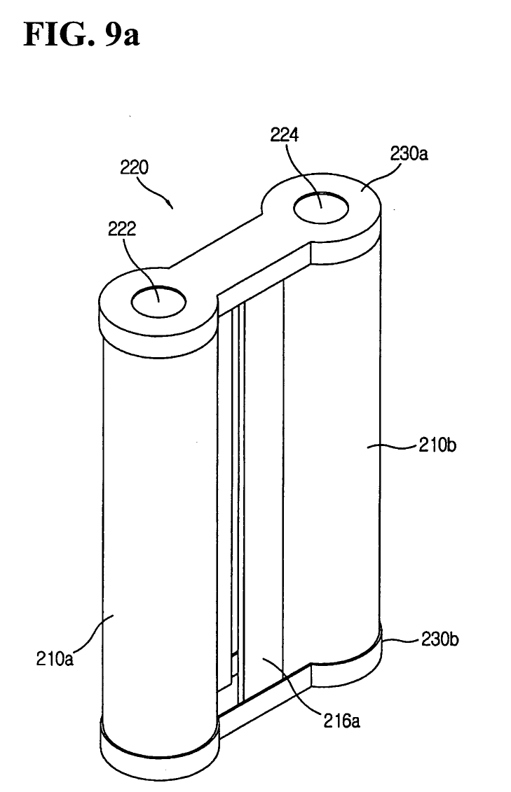

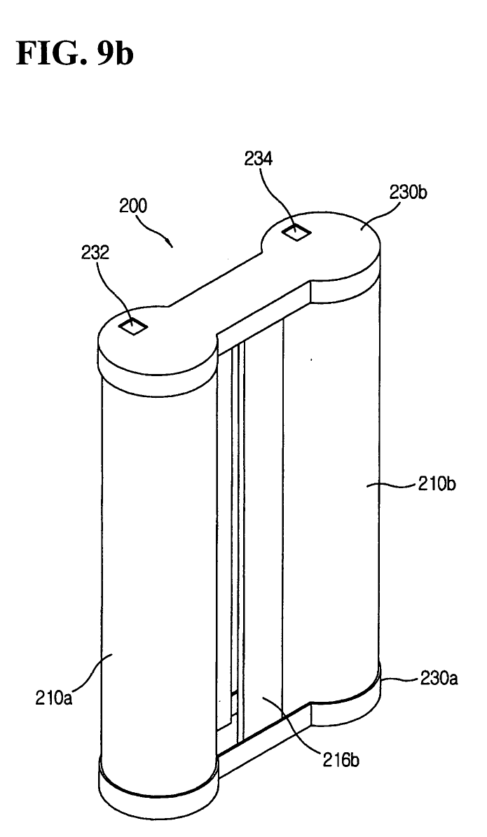

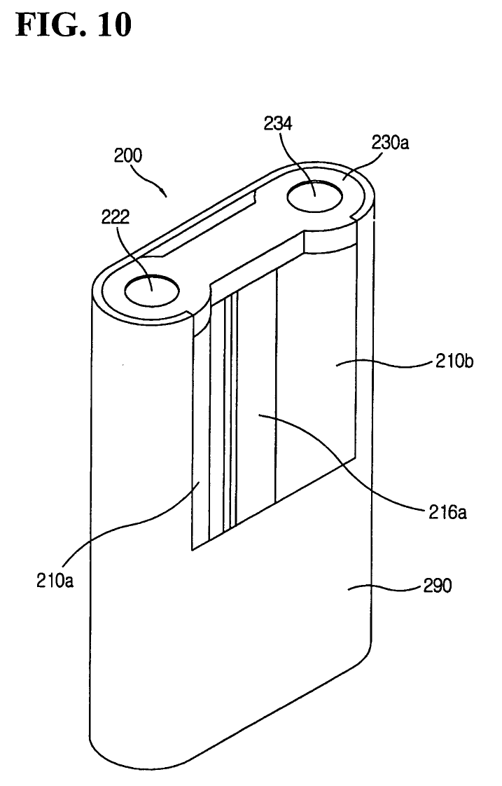

FIGS. 9a and 9b show the discharge terminal and the recharge terminal, respectively, of the batteries constructed according to the second embodiment. FIG. 10 illustrates the shapes of the battery pack assembled from the individual batteries (210a, 210b), onto which a packing label (290) is attached.

As shown in FIG. 9, both anode and cathode terminals are formed at both sides of the upper and the lower parts of the battery pack (200) and these terminals include the discharge terminals (222, 224) which are exposed to the outside through the penetration hole and the recharge terminals (232, 234) which are exposed to the outside in the form of projections. As for the shape and external projection structures of these terminals, it would be apparent to the ordinary skilled that it is possible, contrary to what FIG. 9 shows, to arrange recharge and discharge terminals in the opposite structure, the identical exposure structure, or the identical projection structure.

The circuit board (22) has either battery safety unit alone or both battery safety unit and discharge constant voltage circuit. In general, it is desirable to have the constant voltage circuit formed at the circuit board (220a) which is assembled at the discharge terminal side and to make the battery safety unit formed at the circuit board (220b) which is assembled at the recharge terminal side. The safety unit serves to shut off current from the outside when over-current is charged to the batteries (210a, 210b). It also serves to prevent further discharge when the current charged to the batteries (210a, 210b) is over-discharged to the outside. When the batteries are charged by applying voltage to the battery pack (22), the current applied from an external charger (‘380’ in FIG. 11) flows into the battery pack (200) through the battery safety unit. When the current charged to the battery pack (200) is discharged (or exported) to external electronic appliances (for example, ‘370’ in FIG. 11), the current which was charged to the batteries (210a, 210b) is applied to the discharge constant voltage circuit through the safety unit. It is through this constant voltage circuit that the voltage converted into a constant set voltage is supplied to external electronic appliances.

### FIRST CIRCUITRY EXAMPLE

FIG. 11 is a block circuit diagram showing the battery safety unit (350) and the constant voltage circuit (360) which can be included in the battery pack constructed according to the first and second embodiments.

The battery safety unit (350) includes a voltage detector (352), the first comparator (354), the second comparator (356), and a cut-off switch (358). The battery safety unit serves to eliminate the problem of capacity decline of batteries which occurs when electrical current is continuously supplied from a charger even after an electric charging is completed (380) during the course of recharging the battery pack by applying the current to the battery pack (100, 200) by the external charger (380). For example, when Lithium ion batteries are charged above 4.5V, the electrolytes within the batteries are resolved into gas, which increases the internal pressure of the batteries and causes safety edge to go into action to reduce such pressure. This mechanism can be accompanied by electrolyte leakage. Thus, it is necessary to make sure that Lithium Ion battery is not charged above a certain voltage (for example, 4.2 V).

In this present invention, when the battery pack is supplied with electrical energy and charged up to a rated capacity, the voltage detector (352) of the battery safety unit (350) detects such electrical charging and recognizes voltage value detected by the first comparator (354). In case that the voltage value recognized by the voltage detector (352) is higher than the standard fixed voltage value, the first comparator (354) signals to a cut-off switch (358) in order to have it in an interrupting condition. Once the cut-off switch (358) is in such condition, the charger (380) no longer supplies electrical energy to the battery pack, thereby preventing the over-charge of the battery pack.

On the other hand, when Lithium ion battery is charged below a certain voltage, copper begins to be dissolved into electrolytes and thereby deteriorates battery capacity. In the present invention, when the battery pack is discharged below a fixed voltage during the course of the electrical energy charged to the battery pack being supplied to external electronic appliances (370) though the safety unit (350) and the discharge constant voltage circuit (360), the voltage detector (352) of the battery safety unit (350) detects battery output voltage and apply this output voltage value to the second comparator (356). The second comparator (356) compares the voltage value applied by the voltage detector (352) with the standard fixed voltage value, applies signals to a cut-off switch (358), and turns on the switch (358) in an interrupting condition in case that the battery output voltage is lower than the standard value. This over-discharge safety unit protects the batteries from being discharged below, for example, 2.7V.

In FIG. 11, the discharge constant voltage circuit (360) controls output voltage of the battery pack in order to maintain the output voltage at a predetermined voltage necessary for external electronic appliances. When Lithium Ion batteries make up the battery pack, the recharge voltage of the batteries is within the range of 3V-4.2V, and hence the circuit (360), in case that electrical energy is supplied to external electronic appliances (370), controls the output voltage in order to make sure that a fixed voltage is applied to external electronic appliances from the battery pack. Here, the fixed voltage generated from the battery pack is determined by the operating voltage of external electronic appliances (370) connected to the battery pack. Accordingly, the “fixed voltage” generated from the constant voltage circuit (360) can be a specific DC voltage or a curve-shaped voltage which diminishes (for example, 3.2 V-2.0V) according to time within a fixed range. While the constant voltage circuit (360) is illustrated with reference to FIG. 11 as included within the battery pack, the constant voltage circuit can also be organized inside electronic appliances, depending on the kind of electronic appliances used. In such case, thus, the discharge constant voltage circuit is not built-in inside the battery pack. As for the circuit components in FIG. 11, furthermore, it is possible to combine the battery safety unit (350) and the constant voltage circuit (360) into ‘one chip’ as one IC element and thereby to store in circuit board. In such case, it is advisable to package the one-chip element in COB (Chip on Board) configuration.

### SECOND CIRCUITRY EXAMPLE

FIG. 12 is a block circuit diagram of a battery safety unit (400) according to other embodiment for the circuit. The battery safety unit can be included in the battery pack of the first and second embodiments.

The battery safety unit (400) constructed according to this embodiment includes an over-charge detector (410), an over-discharge detector (420), an over-current detector (430), a short-circuit detector (440), a charger detector (450), a controller, a discharge switch (S1; 470), and a recharge switch (S2; 480).

The two batteries (10a/210a, 10b/210b) built-in within the battery pack are connected to cathode terminals (OUT+, P+1, P+ terminals) and anode terminals (OUT−, P−1, P-terminals) in a row through a controller (460) and switches (470, 480). In case that the voltage of the battery pack is below ODV (over-discharge detection voltage) or over OCV (over-charge detection) and the voltage of voltage detection pin is within the ranges of CDV (charger detection voltage) and OCV (over-current detection voltage), the said batteries are in a normal state of performance. In such a normal state of performance, the controller (460), depending on whether charger connection is detected by the charger detector (450) or not, turns on and off the SI switch (470) or S2 switch (480), thereby causing recharge or discharge movement of the battery pack to occur.

The over-charge detector (410) shuts off the charge switch (480) by the controller (460) when the voltage of the battery pack is over OCV for a fixed time (for example, 0.4-2 seconds) while the battery pack is recharged in a normal state of performance. In case that the voltage of the battery pack falls below OCV, the over charge detector (410) restores the battery pack to a normal state of performance by the controller (460). On the other hand, the over-discharge detector (420) shuts off the discharge switch (470) by the controller (460) in case that the voltage of the battery pack is below ODV for a fixed time (for example, 0.04-600 seconds) while the battery pack is discharged in its normal state of performance. When the voltage of the battery pack is above ODV, the normal state of the battery pack is restored.

The over-current detector (430) shuts off the discharge switch (470) by the controller (460) in case that the discharge current exceeds a certain standard value (for example, in case that the voltage of voltage detection pin exceeds OCV) while the battery pack is discharged in its normal state. Such interception also occurs when cathode and anode terminals are made a short-circuit, and it is detected by the short-circuit detector (440). When such detection occurs by the detector, the controller (460) goes into action and shuts off the switch.

When Lithium Ion batteries make up the battery pack, the recharge current is controlled so that the voltage of the individual batteries included in the pack can reach up to 4.2 V. Lithium Ion batteries are recharged with constant current within the current range of 0.1 CmA and 1.5 CmA, and then their voltage falls by degrees, reaching zero at the end and thus preventing over-discharge of the batteries.

The detailed internal circuit components of the battery safety unit (400) with the above structure can be implemented in various manners. For example, IC which is one of S-8421 series marketed by Seiko instruments can be used for the above internal circuit components. As for the battery safety unit, as explained above by references to FIG. 11, it is advisable to use one-chip module packaged in COB shape. In addition, the discharge constant voltage circuit (360) along with the battery safety unit (400) can be built-in within the battery pack.

Electrical Characteristics

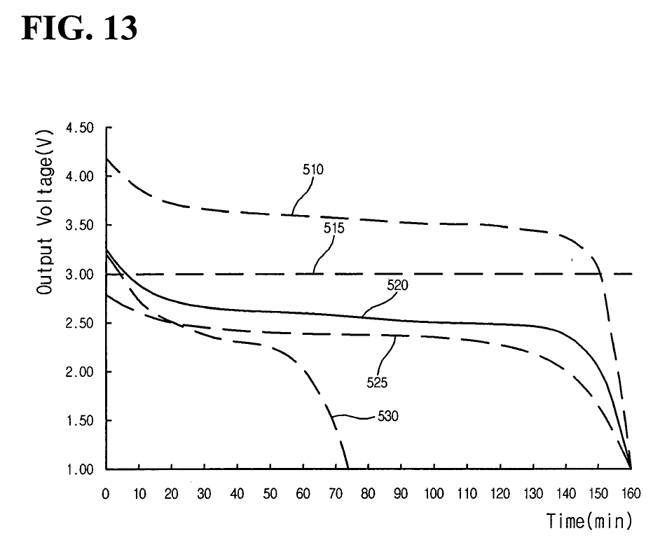

FIGS. 13 to 15 illustrate discharge and recharge characteristics of the battery pack constructed according to the present invention.

In the output voltage characteristic diagram of FIG. 13, the characteristic curve (510) represents output voltage characteristics of the individual batteries (Lithium Ion batteries) included in the battery pack. On the other hand, the standard curve (515) represents output voltage of the battery pack constructed according to the present invention and the curve 525 represents output voltage of traditional Nickel hydrogen batteries. The characteristic curve (530) illustrates output voltage of batteries. As shown in FIG. 13, the present invention, by reducing the output voltage (curve 510) of the individual batteries at a constant rate, causes constant voltage to be generated and can continuously generate normal voltage for approximately 2 hours and 20 minutes.

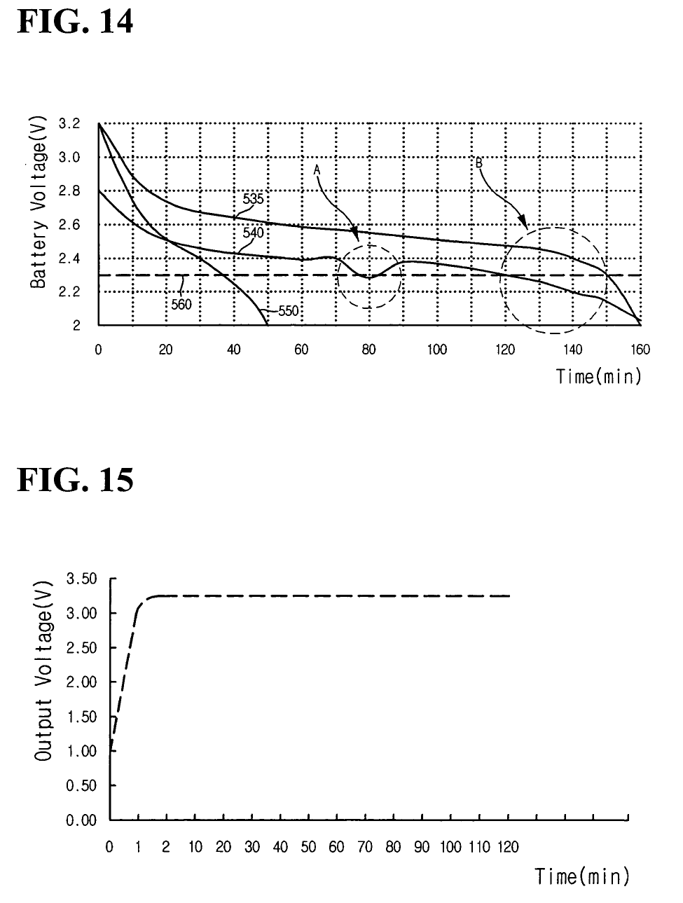

In the output voltage characteristic diagram of FIG. 14, the characteristic curve (535) represents output voltage of the battery pack with 4.29 Wh capacity. On the other hand, the characteristic curve 540 represents the output voltage of Nickel Hydrogen batteries with traditional structures and 4.32 Wh capacity, whereas the characteristic curve 550 illustrates the output voltage of a disposable battery. The standard line 560 symbolizes the movement voltage, 2.3V, of a camera whose average electrical load is 0.6A. As shown in the characteristic curve 540 of FIG. 14, the traditional nickel hydrogen batteries have low output voltage. For this reason, its output voltage can fall below the standard line in an instant (circle A of FIG. 14) in case of over consumption of currents, which causes excessive electrical loads in an instant (for example, the moment the flash bulb of a camera is lighted). In such case, the power suspension of a camera power supply occurs. However, the battery pack, the present invention, maintains an output voltage that is a certain value higher than a standard voltage. Thus, such interception of a camera's power supply does not occur even in the presence of excessive electrical loads in an instant. In other words, although the rated capacity of nickel hydrogen batteries is 4.32 Wh, and thus, higher than that of the present invention (4.29 Wh), the consumption life of the battery pack (that is, the present invention) is substantially longer because the battery pack has even less un-usable remaining capacity than that of traditional batteries (circle B in FIG. 14) when used in electronic machines such as cameras.

FIG. 15 represents a recharge voltage characteristic curve of the battery pack constructed according to the present invention. As shown in the Fig., when recharge current is supplied, the recharge voltage of the battery pack rises to the standard output voltage at once and then maintains the standard value.

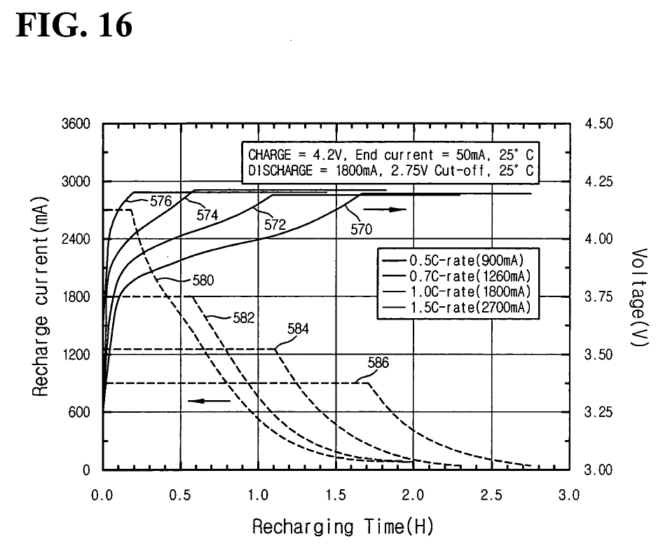

FIG. 16 is a recharge characteristic diagram of the battery pack constructed according to the present invention. In FIG. 16, curves 570, 572, 572, and 276 represent recharge voltage characteristic diagrams of batteries charged at 1.5 CmA (2700 mA), 1.0 CmA (1800 mA), 0.7 CmA (1260 mA), and 0.5 CmA (900 mA) respectively. Here, 1.0 CmA means the current at which battery capacity is charged or discharged in all in one hour. The dotted characteristic diagram 50, 582, 584, and 586 in FIG. 15 represent recharge current characteristic diagrams of battery cells charged at 1.5 CmA (2700 mA), 1.0 CmA (1800 mA), 0.7 CmA (1260 mA), and 0.5 CmA (900 mA) respectively. As shown in these diagrams, when Lithium Ion batteries are recharged for a certain time and their voltages reach in the fixed current environments. Their charge currents are reduced and finally reach zero, thereby preventing over-discharge of the batteries. On the other hand, the Lithium ion battery pack of this invention only requires approximately 80 minutes to be recharged up to 90% process capacity when recharged at 1 CmA voltage current.

Reliability Test Results

Results of reliability tests, conducted between Mar. 17, 2003-Mar. 27, 2003 in Dropping, Vibration, Durability, High and Low Temperatures of 10 sample battery packs that have a standard output voltage of 3.2±0.05V and the maximum standard recharging current of 900 mA are as shown in Tables 2 through 7.

TABLE 1
Test Samples

| | | Sample Number | | | | | | | | | |
|---|---|---|---|---|---|---|---|---|---|---|---|
| Category | Standard | #1 | #2 | #3 | #4 | #5 | #6 | #7 | #8 | #9 | #10 |
| Output | 3.2 +/− 0.05 V | 3.19 | 3.15 | 3.19 | 3.23 | 3.21 | 3.22 | 3.19 | 3.18 | 3.21 | 3.21 |
| Voltage | | | | | | | | | | | |
| Recharging | 900 mA | 30 | 50 | 50 | 40 | 30 | 50 | 40 | 50 | 40 | 30 |
| Current | | | | | | | | | | | |
| Recharging | Min | 110 | 112 | 111 | 113 | 115 | 112 | 115 | 113 | 110 | 111 |
| Time | | | | | | | | | | | |
| Capacity | Min | 89 | 88 | 90 | 90 | 91 | 90 | 90 | 90 | 89 | 88 |

TABLE 2
Dropping (Impact) Test Results (Measurements after dropping the battery pack
weighing 500 g +/− 25 g from 1.3 m height)

| | | | Sample Number | | | | |
|---|---|---|---|---|---|---|---|
| Category | | Standard | #1 | #2 | #3 | #4 | #5 |
| Before | Output | 3.2 +/− 0.05 V | 3.18 | 3.19 | 3.21 | 3.19 | 3.22 |
| | Voltage | | | | | | |
| | Recharging | 900 mA | 30 | 50 | 30 | 50 | 30 |
| | Current | | | | | | |
| | Recharging | Min | 114 | 115 | 115 | 113 | 113 |
| | Time | | | | | | |
| | Capacity | Min | 89 | 90 | 90 | 91 | 89 |
| After | Output | 3.2 +/− 0.05 V | 3.19 | 3.21 | 3.21 | 3.20 | 3.22 |
| | Voltage | | | | | | |
| | Recharging | 900 mA | 30 | 40 | 50 | 30 | 40 |
| | Current | | | | | | |
| | Recharging | Min | 113 | 114 | 113 | 112 | 114 |
| | Time | | | | | | |
| | Capacity | Min | 89 | 88 | 90 | 89 | 90 |

TABLE 3
Vibration Test Results (Applying amplitude 1 mm, frequency 20 Hz-60 Hz waves)

| | | Sample Number | | | | | | | | | |
|---|---|---|---|---|---|---|---|---|---|---|---|
| Category | Standard | #1 | #2 | #3 | #4 | #5 | #6 | #7 | #8 | #9 | #10 |
| Output | 3.2 +/− 0.05 V | 3.18 | 3.19 | 3.21 | 3.21 | 3.19 | 3.18 | 3.21 | 3.22 | 3.19 | 3.21 |
| Voltage | | | | | | | | | | | |
| Recharging | 900 mA | 30 | 50 | 40 | 30 | 50 | 50 | 40 | 60 | 50 | 40 |
| Current | | | | | | | | | | | |
| Recharging | Min | 113 | 115 | 116 | 115 | 113 | 116 | 115 | 114 | 112 | 114 |
| Time | | | | | | | | | | | |
| Capacity | Min | 89 | 89 | 88 | 89 | 90 | 89 | 89 | 89 | 91 | 90 |

TABLE 4
Durability Test (Measurements of the time to exhaust
the voltage after repeating 300 times a complete
recharging and a discharging to 900 mA)

| | | Sample Number | | | | |
|---|---|---|---|---|---|---|
| Category | | #1 | #2 | #3 | #4 | #5 |
| Capacity | Before the | 91.5 | 91.2 | 91.4 | 91.2 | 91.3 |
| (Time) | Test | | | | | |
| (min) | After 10 | 91.8 | 91.2 | 91.3 | 90.9 | 90.8 |
| | times | | | | | |
| | After 20 | 90.5 | 90.8 | 90.8 | 90.8 | 90.7 |
| | times | | | | | |
| | After 30 | 90.2 | 90.3 | 90.4 | 90.5 | 90.5 |
| | times | | | | | |
| | After 40 | 90.5 | 90.7 | 90.7 | 90.6 | 90.8 |
| | times | | | | | |
| | After 50 | 89.9 | 89.6 | 89.8 | 89.5 | 89.7 |
| | times | | | | | |
| | After 60 | 88.6 | 88.9 | 88.4 | 88.7 | 88.2 |
| | times | | | | | |
| | After 70 | 87.5 | 87.6 | 87.8 | 87.9 | 87.9 |
| | times | | | | | |
| | After 80 | 87.2 | 87.4 | 87.3 | 87.5 | 87.4 |
| | times | | | | | |
| | After 90 | 87.6 | 86.9 | 86.2 | 85.8 | 86.9 |
| | times | | | | | |
| | After 100 | 86.2 | 86.4 | 85.9 | 85.1 | 86.3 |
| | times | | | | | |
| | After 140 | 80.2 | 81.1 | 79.9 | 78.8 | 80.5 |
| | times | | | | | |
| | After 180 | 75.6 | 76.5 | 76.3 | 75.2 | 76.2 |
| | times | | | | | |
| | After 220 | 71.8 | 71.4 | 71.1 | 71.1 | 71.6 |
| | times | | | | | |

TABLE 5
Movement Test in High and Low Temperatures (Measurements after
connecting an adapter to the battery pack's input terminal and
a load to output terminal in temperatures of 70° C. and −20° C.
and leaving them for 72 hours.

| | | | Sample Number | | | | |
|---|---|---|---|---|---|---|---|
| Category | | Standard | #1 | #2 | #3 | #4 | #5 |
| After | Output | 3.2 +/− 0.05 V | 3.22 | 3.21 | 3.22 | 3.21 | 3.21 |
| Test | Voltage | | | | | | |
| | Recharging | 900 mA | | | | | |
| | Current | | | | | | |
| | Recharging | Min | | | | | |
| | Time | | | | | | |
| | Capacity | Min | 89 | 90 | 90 | 89 | 90 |
| After | Output | 3.2 +/− 0.05 V | 3.19 | 3.22 | 3.19 | 3.22 | 3.21 |
| Test | Voltage | | | | | | |
| | Recharging | 900 mA | | | | | |
| | Current | | | | | | |
| | Recharging | Min | | | | | |
| | Time | | | | | | |
| | Capacity | Min | 78 | 77 | 78 | 79 | 79 |

TABLE 6
High Temperature High Humidity Durability Test (Measurements after
leaving for 72 hours at 70° C., 60% humidity and then for 24 hours
at a room temperature)

| | | | Sample Number | | | | |
|---|---|---|---|---|---|---|---|
| Category | | Standard | #1 | #2 | #3 | #4 | #5 |
| Be- | Output | 3.2 +/− 0.05 V | 3.21 | 3.22 | 3.19 | 3.22 | 3.21 |
| fore | Voltage | | | | | | |
| | Recharging | 900 mA | 110 | 120 | 110 | 120 | 110 |
| | Current | | | | | | |
| | Recharging | Min | 115 | 116 | 117 | 115 | 118 |
| | Time | | | | | | |
| | Capacity | Min | 91 | 89 | 88 | 90 | 91 |
| After | Output | 3.2 +/− 0.05 V | 3.21 | 3.22 | 3.19 | 3.21 | 3.22 |
| | Voltage | | | | | | |
| | Recharging | 900 mA | 150 | 160 | 130 | 150 | 140 |
| | Current | | | | | | |
| | Recharging | Min | 116 | 118 | 115 | 116 | 118 |
| | Time | | | | | | |
| | Capacity | Min | 91 | 90 | 89 | 89 | 91 |

TABLE 7
Low Temperature Durability Test (Measurements after leaving for 72 hours
at −30° C., and then for 24 hours at a room temperature)

| | | | Sample Number | | | | |
|---|---|---|---|---|---|---|---|
| Category | | Standard | #1 | #2 | #3 | #4 | #5 |
| Before | Output | 3.2 +/− 0.05 V | 3.22 | 3.21 | 3.21 | 3.19 | 3.22 |
| | Voltage | | | | | | |
| | Recharging | 900 mA | 120 | 130 | 150 | 120 | 130 |
| | Current | | | | | | |
| | Recharging | Min | 116 | 118 | 116 | 116 | 117 |
| | Time | | | | | | |
| | Capacity | Min | 89 | 90 | 90 | 88 | 90 |
| After | Output | 3.2 +/− 0.05 V | 3.22 | 3.21 | 3.22 | 3.21 | 3.22 |
| | Voltage | | | | | | |
| | Recharging | 900 mA | 160 | 150 | 160 | 150 | 140 |
| | Current | | | | | | |
| | Recharging | Min | 116 | 113 | 116 | 115 | 116 |
| | Time | | | | | | |
| | Capacity | Min | 91 | 90 | 91 | 91 | 90 |

As shown above in a series of reliability tests, the battery pack of this invention has an excellent lifespan characteristics and durability and proves to be reliable even in harsh conditions.

### INDUSTRIAL APPLICABILITY

As described above, this invention enables to lengthen the battery's usage time and to reuse the batteries for electronic appliances by constructing multiple rechargeable batteries as a single battery pack. Furthermore, the battery pack of this invention is interchangeable with the ordinary commercial batteries and its recharging is quick and easy.

In addition, the battery pack of this invention has an internal battery safety unit designed to shut off the electric current to the battery cell when the current has been over-charged in the recharge electrode and to stop the discharge of the battery pack when the output voltage of the discharge electrode falls below a certain voltage, and thus, improves the battery's reliability.

What is claimed is:

1. A rechargeable battery pack including at least two individual batteries each having cathode and anode terminals, said rechargeable battery pack including:
a recharge electrode and a discharge electrode;
a circuit board onto which a battery safety unit to shut off the electric current to the battery cell when the current is over-charged in the recharge electrode and to stop the discharge of the battery pack when the output voltage of the discharge electrode falls below a certain voltage is built;
a cathode connecting conductor that connects the recharge and discharge electrodes to the cathode terminals of the individual batteries;
an anode connecting conductor that connects the recharge and discharge electrodes to the anode terminals of the individual batteries;
a cover that contains a circuit board and ties the individual batteries, the cathode connecting conductor, the anode connecting conductor and the circuit board as a single battery pack format in the individual batteries' upper bodies where the cathode terminals are formed and in the individual batteries' lower body where the anode terminals are formed; and
at least one of said cathode connecting conductor and said anode connecting conductor is electrically connected to the circuit board.

2. The battery pack as set forth in claim 1, wherein
the cathode connecting conductor is a cross-shaped connecting conductor cutting across the cathode and anode terminals of individual batteries,
and the anode connecting conductor includes the second anode connecting conductor that connects directly to the anode terminals of the individual batteries and the first anode connecting conductor that is a cross-shaped connecting conductor that cuts across the cathode and anode terminals.

3. The battery pack as set forth in claim 1, wherein
the cathode connecting conductor includes a first plate-shaped connecting conductor that directly connects to the cathode terminal of an individual battery and a first line-shaped sub-conductor that attaches to the first insulator plate and connects to the first plate-shaped connecting conductor before extending to the anode terminal of an individual battery, and
the anode connecting conductor includes a second plate-shaped connecting conductor that directly connects to the anode terminal of an individual battery and a second line-shaped sub-conductor that attaches to the second insulator plate and connects to the second plate-shaped connecting conductor before extending to the cathode terminal.

4. The battery pack as set forth in claim 1, wherein said battery safety unit includes:
a cut-off switch connected between the battery pack and the external electronic appliances or external recharging devices;
a voltage sensor for detecting an output voltage of the battery pack;
a first voltage comparator for turning on the cut-off switch when the output voltage is higher than a fixed voltage for over-charge; and
a second voltage comparator for turning on the cut-off switch when the voltage is lower than a fixed voltage for over-discharge.

5. The battery pack as set forth in claim 1, wherein
said battery safety unit includes an over-charge detector, an over-discharge detector, an over-current detector, a short-circuit detector, a recharge comparator, a discharge switch, a charge switch and a circuit controller,
the circuit controller is connected among the electrodes of the battery pack, switches and individual batteries,
the overcharge detector turns off the charge switch through a controller in case of the voltage of battery pack reaching higher than the over-charge detection voltage threshold,
the over-discharge detector turns off the discharge switch through a controller in case of the voltage of battery pack reaching below the discharge detection voltage threshold, and
the over-current detector and the short-circuit detector turn off the charge switch in case of discharge current of the battery pack exceeding a standard value.

6. The battery pack as set forth in claim 4 or 6 further includes a constant-voltage circuit for controlling an output voltage of the individual batteries.

7. A rechargeable battery pack including at least two individual batteries each having cathode and anode terminals, said rechargeable battery pack including:
a recharge electrode and a discharge electrode;
a circuit board that contains a battery safety unit shut off the electric current to the battery cell when the current has been over-charged in the recharge electrode and to stop the discharge of the battery pack when the output voltage of the discharge electrode falls below a certain voltage;
a cathode connecting conductor that electrically connects the recharge electrode to the cathode terminals of an individual battery by connecting them in a series;
an anode connecting conductor that connects the anode terminals in a series and electrically connects them to the recharge and discharge electrodes through the battery safety unit in the circuit board;
a fixing cap that holds the circuit board; and
a cover that ties the individual batteries, the fixing cap, the cathode connecting conductor, the anode connecting conductor and the circuit board as a single battery pack format in the individual battery's upper body that has a cathode terminal and its lower body that has an anode terminal.

8. A rechargeable battery pack including at least two individual batteries each having cathode and anode terminals, said rechargeable battery pack including:
a recharge electrode and a discharge electrode;
a circuit board that contains a battery safety unit shut off the electric current to the battery cell when the current has been over-charged in the recharge electrode and to stop the discharge of the battery pack when the output voltage of the discharge electrode falls below a certain voltage;
a cathode connecting conductor for electrically connecting the cathode terminal of an individual battery to the recharge and discharge electrodes which includes first plate-shaped connecting conductor that directly connects to the cathode terminal of an individual battery and the first line-shaped connecting that attaches to the first insulator plate and connects to the first plate-shaped connecting conductor before extending to the anode terminal of an individual battery;
an anode connecting conductor for electrically connecting the anode terminal to the recharge and discharge electrodes through the battery safety unit in the circuit board which includes both the second plate-shaped connecting conductor that directly connects to the anode terminal of an individual battery and the second line-shape supplement conductor that attaches to the second insulator plate and connects to the second plate-shaped connecting conductor before extending to the cathode terminal; and
a cover that ties the individual batteries, the fixing cap, the cathode connecting conductor, the anode connecting conductor and the circuit board as a single battery pack format in the individual battery's upper body that has a cathode terminal and its lower body that has an anode terminal.

9. The battery pack as set forth in claim 7 or 8, wherein said battery safety unit includes:
a cut-off switch connected between the battery pack and external electronic appliances or external recharging devices;
a voltage sensor that senses the output voltage of the battery pack;
a first voltage comparator that turns on the cut-off switch when the output voltage is higher than a fixed threshold voltage for over-charge; and
a second voltage comparator that turns on the cut-off switch when the voltage is lower than a fixed threshold voltage for over-discharge.

10. The battery pack as set forth in claim 9, wherein
said cut-off switch includes both recharge and discharge switches, and the battery safety unit additionally includes over-current detector which shuts off the discharge switch when the discharge voltage becomes higher than the fixed standard value as well as a short-circuit detector.

11. Method for manufacturing a rechargeable battery pack including at least two individual batteries each having cathode and anode terminals, said method including steps of:
combining individual batteries using binding materials;
preparing a circuit board that contains a battery safety unit shut off the electric current to the battery cell when electric current is over-charged in the recharge electrode and to stop the discharge of the battery pack when the output voltage of the discharge electrode falls below a certain voltage;
bonding a cathode connecting conductor and a anode connecting conductor to the circuit board, said cathode connecting conductor electrically connecting the cathode terminals of the individual batteries to the recharge electrode and said anode connecting conductor electrically connecting the anode terminals of the individual batteries to recharge electrode; and
assembling a cover that ties the individual batteries, the cathode connecting conductor, the anode connecting conductor and the circuit board as a single battery pack format in the individual battery's upper body that has the cathode terminal and its lower body that has the anode terminal.
